(19) United States
(12) Patent Application Publication
(10) Pub. No.: US 2007/0016685 A1
(43) Pub. Date: Jan. 18, 2007

(54) Buffer overflow proxy

(75) Inventor: Jeffery L. Crume, Raleigh, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 11/180,376

(22) Filed: Jul. 13, 2005

(51) Int. Cl. G06F 15/16

(52) U.S. Cl. 709/232

(57) ABSTRACT

A buffer overflow proxy the sits in front of a target application and ensures that one or more characteristics of the incoming data conforms a one or more rules established for the target application. A system is disclosed for processing incoming data bound for a server system that serves at least one network application, wherein the buffer overflow proxy system comprises: a data analysis system that determines a set of characteristics of the incoming data before the incoming data reaches the server system; a rules database that includes data input rules for the at least one network application; and a rules application system that selects and applies at least one data input rule to a characteristic of the incoming data.

### BACKGROUND OF THE INVENTION

1. Technical Field

The present invention relates generally to computer security, and more specifically relates to a buffer overflow proxy that guards against denial of service and other attacks involving buffer overflows.

2. Related Art

Buffer overflows are one of the most common vulnerabilities exploited by attackers. Buffer overflow attacks typically involve an attacker loading an input buffer of a computer application with significantly more data than the application can handle, which causes the application to malfunction. Buffer overflows can be exploited to launch denial of service (DoS) attacks as well as to allow a remote attacker the ability to run the code of their choosing on the target system. Often, the attacker is able to obtain root or administrator privileges. In 1998, more than half of the security advisories issued by CERT (Computer Emergency Response Team) were due to buffer overflows and very little has changed in the intervening years to address the problem.

Unfortunately, there is often very little that an organization can to do protect against buffer overflows, especially if the software they use was created by another organization (which is typically the case). Traditional defenses involve hardening target systems, applying software patches in a timely manner and limiting access through firewalls. However, these measures alone have proven insufficient as buffer overflow vulnerabilities continue to be exploited with regularity.

Buffer overflow vulnerabilities exist due to poor programming practices yet despite years of emphasis on this point by the information technology (IT) security community, the incidence of such problems has not abated. Therefore, it is clear that continuing to rely on programmers to add exhaustive input validation routines to all software they create will never be sufficient.

Accordingly, a need exists for a system that can effectively prevent buffer overflow attacks.

### SUMMARY OF THE INVENTION

The present invention addresses the above-mentioned problems, as well as others, by providing a buffer overflow proxy that sits in front of a target application and ensures that one or more characteristics of the incoming data conforms to one or more rules established for the target application. In a first aspect, the invention provides a buffer overflow proxy system for processing incoming data bound for a server system that serves at least one network application, wherein the buffer overflow proxy system comprises: a data analysis system that determines a set of characteristics of the incoming data before the incoming data reaches the server system; a rules database that includes data input rules for the at least one network application; and a rules application system that selects and applies at least one data input rule to a characteristic of the incoming data.

In a second aspect, the invention provides a method of processing incoming data bound for a server system that serves at least one network application, wherein the method comprises: determining a set of characteristics of the incoming data prior to the server system; providing a rules database that includes data input rules for the at least one network application; and selecting and applying at least one data input rule to a characteristic of the incoming data to determine if the incoming data conforms to a requirement of the at least one data input rule.

In a third aspect, the invention provides a computer program product stored on a computer readable medium for processing incoming data bound for a server system that serves at least one network application, wherein the method comprises: program code configured for determining a set of characteristics of the incoming data before the incoming data reaches the server system; a rules database that includes data input rules for the at least one network application; and program code configured for selecting and applying at least one data input rule to a characteristic of the incoming data to determine if the incoming data conforms to a requirement of the at least one data input rule.

In a fourth aspect, the invention provides a method for deploying a buffer overflow proxy system, comprising: providing a computer infrastructure being operable to: determine a set of characteristics of incoming data before the incoming data reaches a targeted server system; and select and apply at least one data input rule from a rules database to a characteristic of the incoming data to determine if the incoming data conforms to a requirement of the at least one data input rule.

In a fifth aspect, the invention provides computer software embodied in a propagated signal for deploying a buffer overflow proxy system, the computer software comprising instructions to cause a computer to perform the following functions: determine a set of characteristics of incoming data before the incoming data reaches a targeted server system; and select and apply at least one data input rule from a rules database to a characteristic of the incoming data to determine if the incoming data conforms to a requirement of the at least one data input rule.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a network architecture including a buffer overflow proxy in accordance with the present invention.

FIG. 2 depicts a computer system having buffer overflow proxy system in accordance with the present invention.

### DETAILED DESCRIPTION OF THE INVENTION

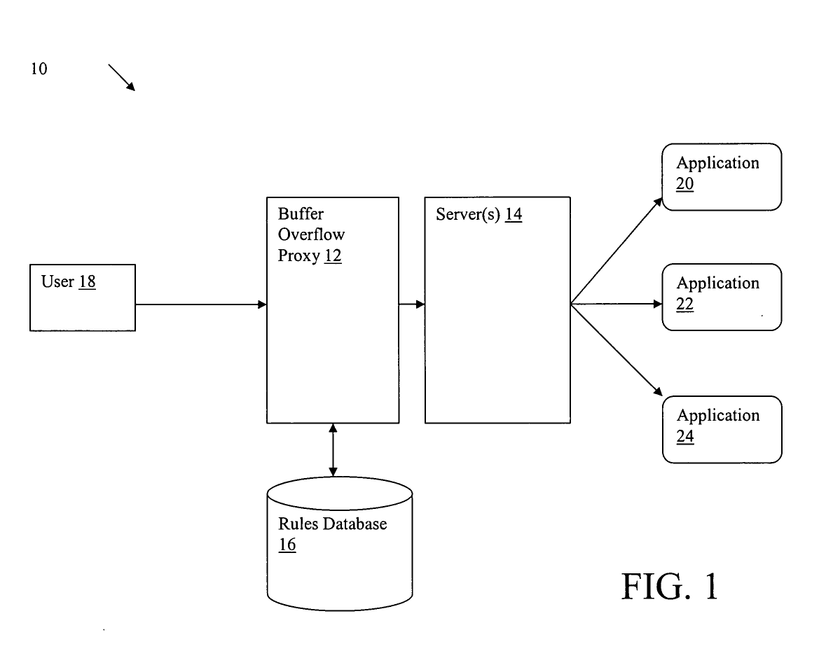

Referring now to the drawings, FIG. 1 depicts a network architecture 10 that include includes a buffer overflow proxy 12 that sits between the user 18 and one or more network applications 20, 22, 24, which are accessed via server(s) 14. The buffer overflow proxy 12 provides an additional layer of defense by checking inputs of incoming data bound for server(s) 14 against a predefined set of acceptable values and lengths in order to catch buffer overflow attacks before they ever reach one of the applications 20, 22, 24. By centralizing the input validation function into a separate logical (or physical) component, a wide range of applications 20, 22, 24 can benefit from protection without having to specifically instrument each one independently. Also, by providing a common point of vetting incoming data, this type of defense need only be implemented once in the buffer overflow proxy 12, rather than in each vulnerable application 20, 22, 24 thereby reducing coding efforts and improving security and consistency. Adding a buffer overflow proxy 12 that shields vulnerable applications is in keeping with the security principle of “defense in depth” and provides greater assurance that proper vetting will be done.

Note that while this illustrative embodiment is focused on buffer overflow issues, the described features could also be extended to defend against other attacks exploiting inadequate input validation, such as the use of invalid characters, injection attacks (e.g., SQL injection) and other widely-known techniques.

As can be seen, the buffer overflow proxy 12 is positioned between the user 18 (potential attacker) and the server/target application. All supplied inputs by user 18 would be subject to inspection by the buffer overflow proxy 12 before being passed to the application. Since buffer overflow attacks involve sending more data than is expected to a target system (e.g., 50 bytes reserved to hold a user's last name but 50,000 bytes are received), the buffer overflow proxy 12 would consult a rules list to determine if the incoming data conforms to predetermined size limitations. If it does not conform, appropriate action could be taken, e.g., extraneous data could be discarded and only a truncated input would be passed to the application. As such, the buffer overflow proxy 12 would essentially act as a shield against improper inputs that could result in an exploitable buffer overflow in a sensitive application. In addition to size limitations, this approach could be applied to other input validation checks, such as those for invalid characters and SQL injections attacks, thereby providing consistent, reliable protection against a wide range of potential attacks.

Buffer overflow proxy 12 could be deployed in front of any type of server(s) 14, including application servers, e.g., using Web services, Web page servers and email servers. Validation rules corresponding to each server/application type would be retrieved from a rules database 16 and applied to the inbound traffic intended for that server/application type.

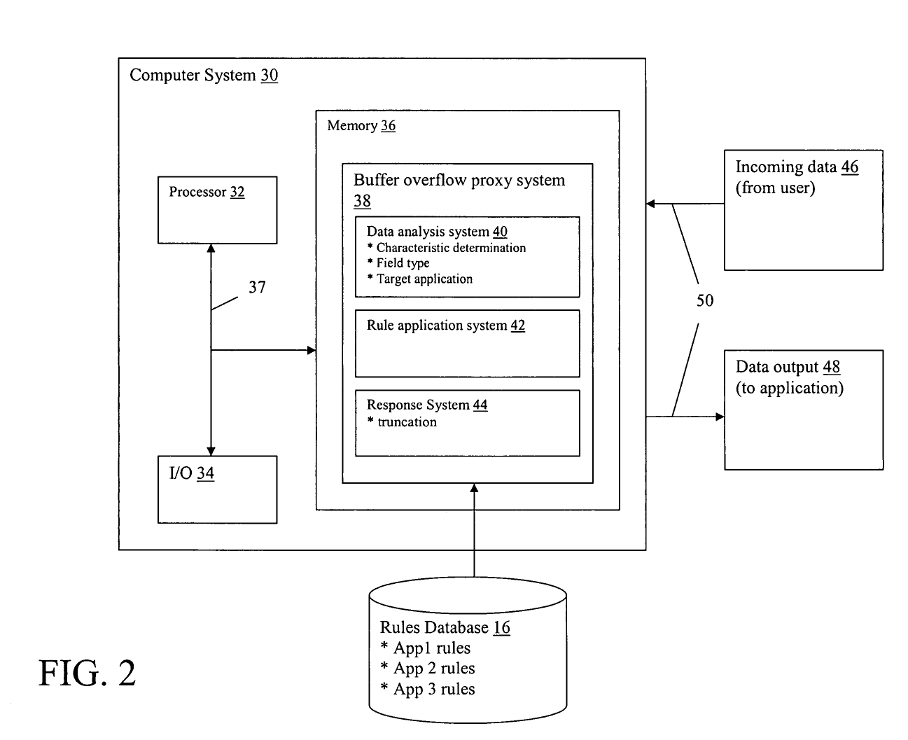

Referring now to FIG. 2, a computer system 30 is depicted comprising a buffer overflow proxy system 38. In general, computer system 30 may comprise any type of computer system, e.g., a desktop, a laptop, a workstation, etc. Moreover, computer system 30 could be implemented as a proxy server in a buffer zone between firewalls. Computer system 30 generally includes a processor 32, input/output (I/O) 34, memory 36, and bus 37. The processor 32 may comprise a single processing unit, or be distributed across one or more processing units in one or more locations, e.g., on a client and server. Memory 36 may comprise any known type of data storage and/or transmission media, including magnetic media, optical media, random access memory (RAM), read-only memory (ROM), a data cache, a data object, etc. Moreover, memory 36 may reside at a single physical location, comprising one or more types of data storage, or be distributed across a plurality of physical systems in various forms.

I/O 34 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 37 provides a communication link between each of the components in the computer system 30 and likewise may comprise any known type of transmission link, including electrical, optical, wireless, etc. Although not shown, additional components, such as cache memory, communication systems, system software, etc., may be incorporated into computer system 30.

Access to computer system 30 may be provided over a network 50 such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

Rules database 16 may likewise be implemented in any fashion. For instance, it may be implemented as a relational database, a flat file, a data object, a table, etc. Moreover, it may be implemented locally, remotely, as a single physical database, or as a distributed database, e.g., distributed across the Internet.

Buffer overflow system 38 includes a data analysis system 40, a rule application system 42, and a response system 44. Data analysis system 40 analyzes the incoming data 46 to determine a set (i.e., one or more) characteristics of the incoming data 46. For instance, data analysis system 40 may determine a size of the incoming data 46; determine a data type of the incoming data 46 (e.g., does the data contain integers, letters, special characters, etc.), ascertain a purpose of the incoming data 46 (e.g., a name field, an email address, etc.), and ascertain the targeted server/application (e.g., an email application, a web application, etc.).

Based on the set of characteristics collected for the incoming data 46, one or more applicable rules are identified from the rules database 16 and applied to the incoming data 46. In one illustrative embodiment, each application (App1, App2, App3) would have its own set of rules for different data input fields. For instance, for a name field for a Web application, a rule may demand that the incoming data 46 be less than 50 characters and contain no special characters. If the incoming data 46 conforms to or passes the applied rule or rules, then the data output 48 is passed along to the appropriate application. However, if one of the applied rules does not conform or fails, then response system 44 is implemented to apply an appropriate response based on the failed rule. In an illustrative case where too many characters were provided for input, response system 44 could simply truncate the incoming data 46 down to a size that is allowable by the rule. Obviously, other responses could be implemented, e.g., passing characters containing a warning to the target application, etc.

It should be appreciated that the teachings of the present invention could be offered as a business method on a subscription or fee basis. For example, a computer system 30 comprising buffer overflow proxy system could be created, maintained and/or deployed by a service provider that offers the functions described herein for customers. That is, a service provider could offer to provide buffer overflow checking as described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A buffer overflow proxy system for processing incoming data bound for a server system that serves at least one network application, wherein the buffer overflow proxy system comprises:
a data analysis system that determines a set of characteristics of the incoming data before the incoming data reaches the server system;
a rules database that includes data input rules for the at least one network application; and
a rules application system that selects and applies at least one data input rule to a characteristic of the incoming data.

2. The buffer overflow proxy system of claim 1, wherein the at least one data input rule checks a size of the incoming data, and causes the incoming data to be truncated if the size is greater than an amount allowed by the at least one data input rule.

3. The buffer overflow proxy system of claim 1, wherein the at least one network application is selected from the group consisting of: an email application, a website application, and a web services application.

4. The buffer overflow proxy system of claim 1, wherein the at least one data input rule checks a data type of the incoming data for invalid characters.

5. The buffer overflow proxy system of claim 1, wherein the at least one data input rule checks a data type of the incoming data for SQL injection attacks.

6. A method of processing incoming data bound for a server system that serves at least one network application, wherein the method comprises:
determining a set of characteristics of the incoming data prior to the server system;
providing a rules database that includes data input rules for the at least one network application; and
selecting and applying at least one data input rule to a characteristic of the incoming data to determine if the incoming data conforms to a requirement of the at least one data input rule.

7. The method of claim 6, wherein the at least one data input rule checks a size of the incoming data, and causes the incoming data to be truncated before reaching the server system if the size is greater than an amount allowed by the at least one data input rule.

8. The method of claim 6, wherein the at least one network application is selected from the group consisting of: an email application, a website application, and a web services application.

9. The method of claim 6, wherein the at least one data input rule checks a data type of the incoming data for invalid characters.

10. The method of claim 6, wherein the at least one data input rule checks a data type of the incoming data for SQL injection attacks.

11. A computer program product stored on a computer readable medium for processing incoming data bound for a server system that serves at least one network application, wherein the method comprises:
program code configured for determining a set of characteristics of the incoming data before the incoming data reaches the server system;
a rules database that includes data input rules for the at least one network application; and
program code configured for selecting and applying at least one data input rule to a characteristic of the incoming data to determine if the incoming data conforms to a requirement of the at least one data input rule.

12. The computer program product of claim 11, wherein the at least one data input rule checks a size of the incoming data, and causes the incoming data to be truncated before reaching the server system if the size is greater than an amount allowed by the at least one data input rule.

13. The computer program product of claim 11, wherein the at least one network application is selected from the group consisting of: an email application, a website application, and a web services application.

14. The computer program product of claim 11, wherein the at least one data input rule checks a data type of the incoming data for invalid characters.

15. The computer program product of claim 11, wherein the at least one data input rule checks a data type of the incoming data for SQL injection attacks.

16. A method for deploying a buffer overflow proxy system, comprising:
providing a computer infrastructure being operable to:
determine a set of characteristics of incoming data before the incoming data reaches a targeted server system; and
select and apply at least one data input rule from a rules database to a characteristic of the incoming data to determine if the incoming data conforms to a requirement of the at least one data input rule.

17. Computer software embodied in a propagated signal for deploying a buffer overflow proxy system, the computer software comprising instructions to cause a computer to perform the following functions:
determine a set of characteristics of incoming data before the incoming data reaches a targeted server system; and
select and apply at least one data input rule from a rules database to a characteristic of the incoming data to determine if the incoming data conforms to a requirement of the at least one data input rule.
